(19) United States
(12) Patent Application Publication
(10) Pub. No.: US 2001/0040857 A1
(43) Pub. Date: Nov. 15, 2001

(54) OPTICAL DISK RECORDING/REPRODUCTION APPARATUS

(76) Inventor: SATOSHI SUGAYA, TOKYO (JP)

Correspondence Address: MCGINN & GIBB, 8321 OLD COURTHOUSE ROAD, SUITE 200, VIENNA, VA, 22182, US

(21) Appl. No.: 09/179,096

(22) Filed: Oct. 27, 1998

(30) Foreign Application Priority Data
Oct. 28, 1997 (JP) 295630/1997

(51) Int. Cl. G11B 17/04; G11B 17/08

(52) U.S. Cl. 369/192

(57) ABSTRACT

An optical disk recording/reproduction apparatus includes a cartridge, a turntable, an optical disk transfer unit, and an optical head. Two optical disks are stored in the cartridge. The optical disk is mounted and rotated on the turntable. The optical disk transfer unit transfers the optical disk between the cartridge and the turntable. The optical head irradiates the optical disk mounted on the turntable with a light beam to record/reproduce data.

### BACKGROUND OF THE INVENTION

The present invention relates to an optical disk recording/reproduction apparatus for recording and reproducing data on and from an optical disk and, more particularly, to an optical disk recording/reproduction apparatus capable of realizing double-capacity recording/reproduction with one cartridge by storing two optical disks in the cartridge.

An optical disk recording/reproduction apparatus has a very high recording density because data is recorded/reproduced by focusing the laser beam to the diffraction limit in the wavelength order by an objective lens and irradiating the surface of the recording film of the optical disk. Since the optical disk recording/reproduction apparatus uses light for recording/reproduction, the optical disk and the optical head always keep a noncontact state, and the data reliability is high. Further, since the laser beam is incident on the optical disk via a transparent substrate, the disk is resistant to dust, dirt, and contamination of the substrate surface, can be exchanged, and can be easily carried. From these features, the optical disk has extensively been studied and developed, and is becoming popular.

In recent years, optical disks are increased in density and capacity. A DVD-RAM (Digital Versatile Disk Random Access Memory), as an erasable optical disk being standardized, has a large recording capacity of about 2.6 GB for one 120-mm disk, which is 4 times or more the capacity of a conventional CD-ROM (Compact Disk Read Only Memory). Even the capacity of the DVD-RAM allows to record image data of MPEG2 (Moving Picture Experts Group 2) for only 1 h and not to record one movie. Recording/reproducing an important movie as multimedia data requires two optical disks, so the optical disks must be exchanged during recording/reproduction. This bothers the user and interferes wide spread of the DVD-RAM.

On the other hand, a next-generation DVD-RAM having a 5-GB class recording capacity for one optical disk is developed using the signal processing technique and the recording/reproduction technique. However, when image data of a long recording time or high-quality image data such as high-vision image data is to be recorded/reproduced, the data must be recorded on two optical disks, and the two optical disks must also be exchanged.

As a method of increasing the capacity of the optical disk, two optical disks are adhered to realize a large capacity corresponding to two disks by the upper and lower surfaces. However, to record/reproduce data on the upper and lower surfaces of the double-sided optical disk, the disk must be temporarily extracted from the optical disk recording/reproduction apparatus and turned over. Eliminating the step of turning the optical disk over requires a mechanism for allowing the optical head to access both the upper and lower surfaces of the optical disk.

Further, as a method of increasing the capacity of the optical disk, the recording film is examined to be formed from two layers to realize a large capacity corresponding to two disks by an access to one side. However, this method cannot be practically used yet in terms of the optical utilization factor and the performance.

For example, a disk changer optical disk recording/reproduction apparatus is disclosed in “Disk Changer”, Japanese Patent Laid-Open No. 2-273372. When a case in which a plurality of optical disks are stored is inserted, the disk changer optical disk recording/reproduction apparatus automatically exchanges the optical disks and records/reproduces data on/from the respective optical disks. Compared to a conventional cartridge for storing one optical disk, the case for storing a plurality of optical disks becomes bulky and is not compatible with the conventional cartridge. In addition, the optical disk recording/reproduction apparatus requires a mechanism for loading the large-size case and inserting/extracting the optical disk from the case, so that the apparatus increases in size and cannot be made thin.

As described above, when data cannot be recorded on one optical disk, the optical disk must be exchanged during recording/reproduction.

In the double-sided optical disk, realizing a double-sided access without turning the optical disk over complicates the mechanism of the optical disk recording/reproduction apparatus, increases the cost of the apparatus, and makes it difficult to attain a low-profile apparatus.

In the disk changer optical disk recording/reproduction apparatus, the compatibility cannot be established with the conventional cartridge, the mechanism is complicated, and the apparatus is bulky.

In the disk changer optical disk recording/reproduction apparatus, since data cannot be recorded/reproduced while the optical disk is exchanged inside the optical disk recording/reproduction apparatus, recording/reproduction of data is interrupted during exchange of the optical disk.

### SUMMARY OF THE INVENTION

It is an object of the present invention to provide an optical disk recording/reproduction apparatus capable of recording/reproducing with a capacity corresponding to two optical disks without exchanging the optical disk.

It is another object of the present invention to provide a compact, low-profile optical disk recording/reproduction apparatus.

It is still another object of the present invention to provide an optical disk recording/reproduction apparatus capable of easily realizing the compatibility with a conventional cartridge for storing one optical disk.

It is still another object of the present invention to provide an optical disk recording/reproduction apparatus capable of recording/reproduction without any interruption during exchange of the optical disk.

To achieve the above objects, according to the present invention, there is provided an optical disk recording/reproduction apparatus comprising a cartridge for storing two optical disks, a turntable for mounting and rotating an optical disk, an optical disk transfer unit for transferring the optical disk between the cartridge and the turntable, and an optical head for irradiating the optical disk mounted on the turntable with a light beam to record/reproduce data.

### BRIEF DESCRIPTION OF THE DRAWINGS

FIG. 1 is a perspective view showing the arrangement of an optical disk recording/reproduction apparatus according to the first embodiment of the present invention;

FIG. 2 is a perspective view showing the arrangement of a cartridge and an optical disk according to the first embodiment of the present invention;

FIG. 3 is a perspective view showing the arrangement of the cartridge and the optical disk according to the first embodiment of the present invention;

FIG. 4 is a plan view showing the arrangement of the cartridge and the optical disk according to the first embodiment of the present invention;

FIG. 5 is a plan view showing the arrangement of the cartridge and the optical disk according to the first embodiment of the present invention;

FIG. 6 is a sectional view showing the arrangement of the cartridge and the optical disk according to the first embodiment of the present invention;

FIG. 7 is a perspective view showing the state wherein the cartridge is inserted in the optical disk recording/reproduction apparatus in the first embodiment of the present invention; and

FIGS. 8A to 8H are explanatory views showing the operation of recording/reproducing data on/from the optical disk in the first embodiment of the present invention.

### DESCRIPTION OF THE PREFERRED EMBODIMENT

An embodiment of the present invention will be described in detail below with reference to the accompanying drawings.

First Embodiment

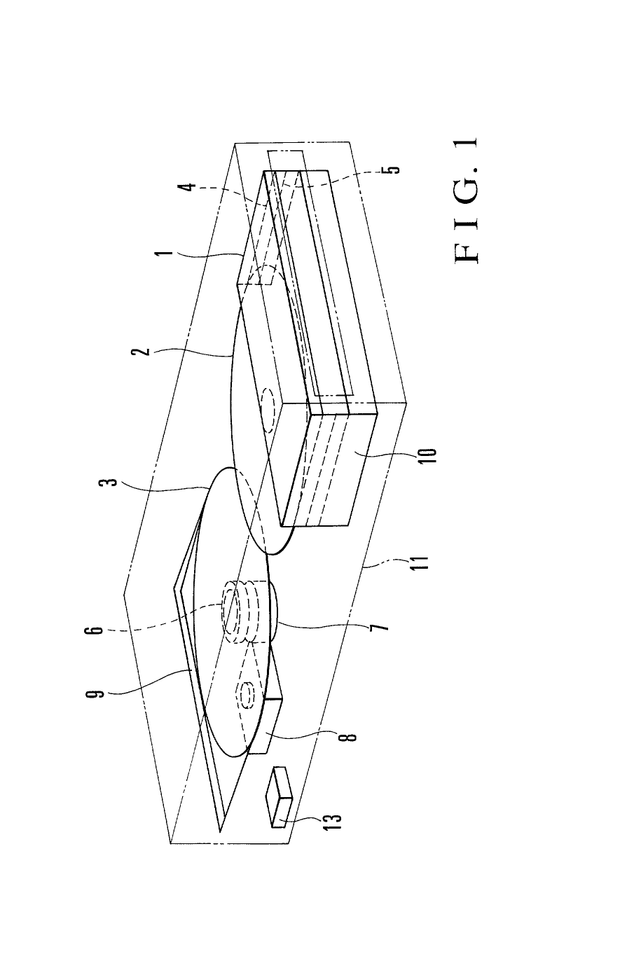

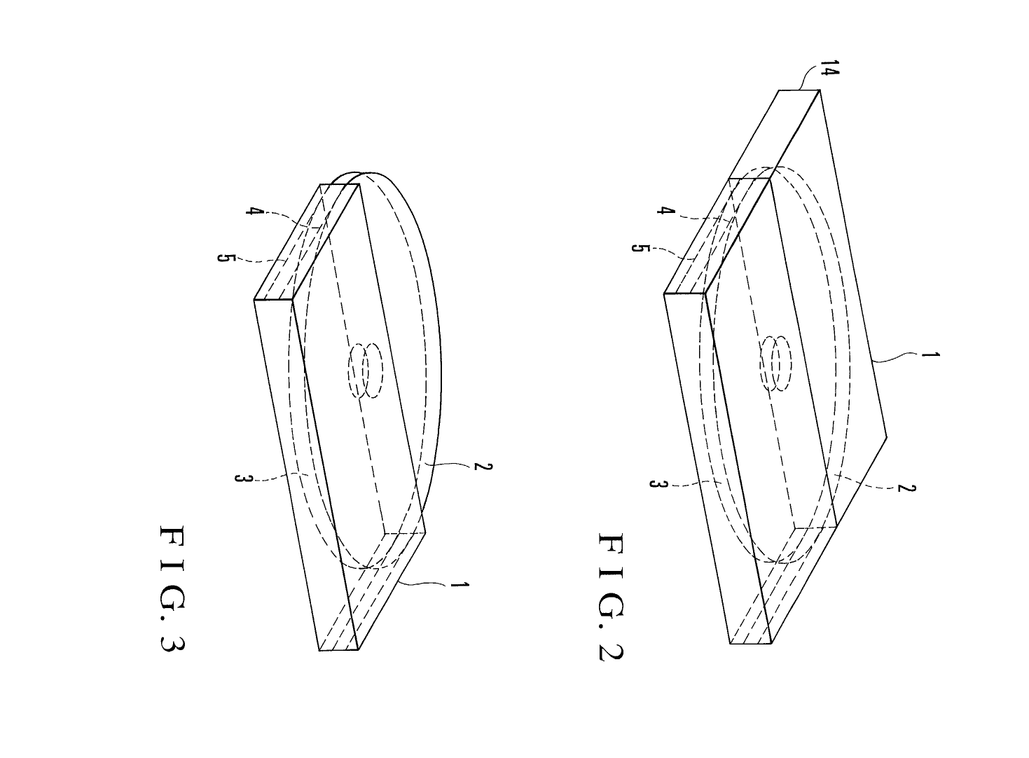

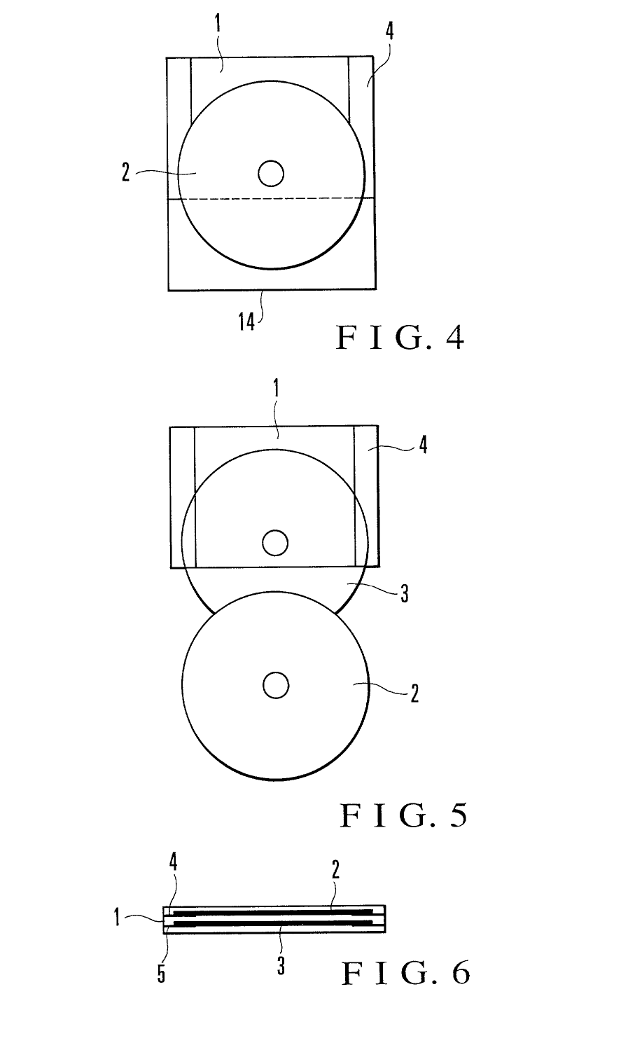

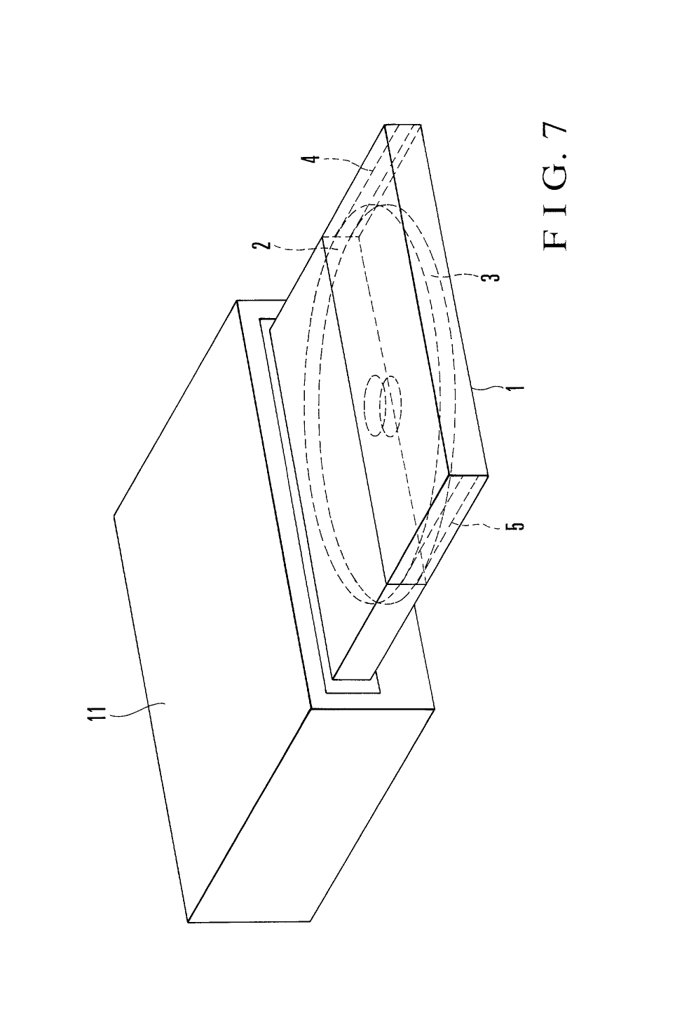

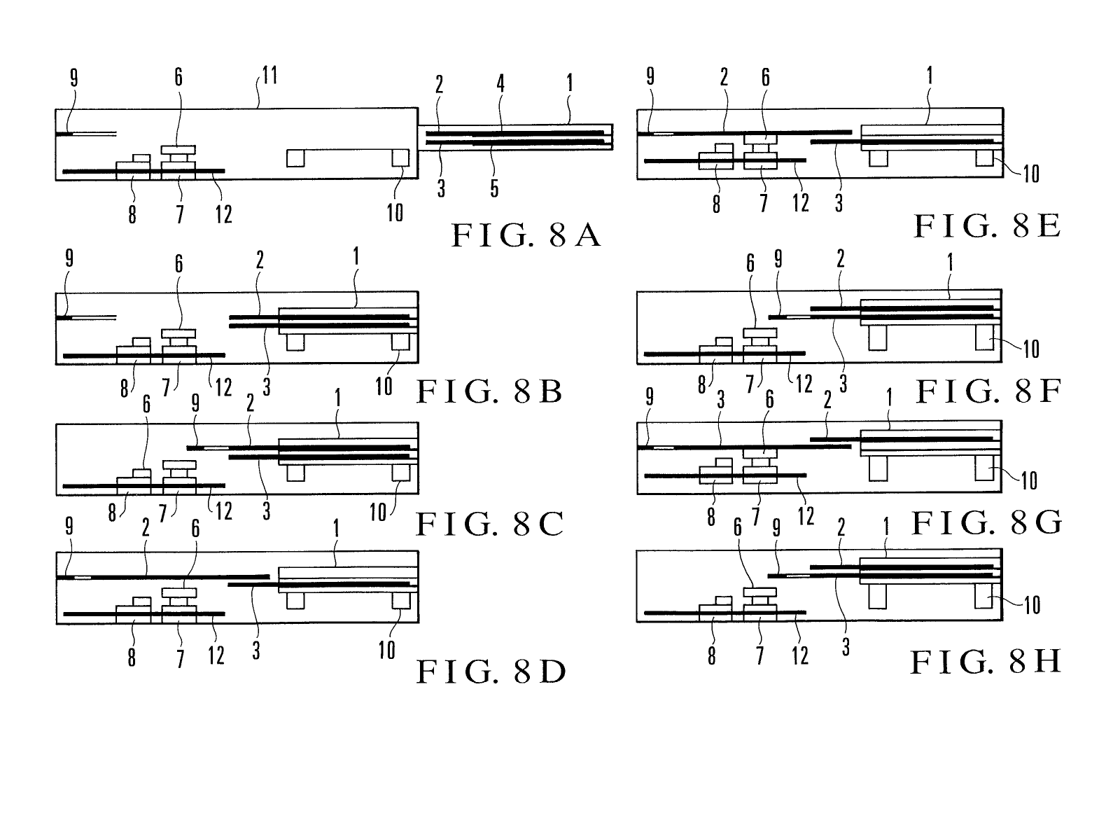

FIG. 1 shows the arrangement of an optical disk recording/reproduction apparatus 11 according to the first embodiment of the present invention. FIGS. 2 and 3 show the arrangement of a cartridge 1 and optical disks 2 and 3 according to the first embodiment of the present invention. FIG. 2 shows the state wherein the cartridge 1 is not inserted in the optical disk recording/reproduction apparatus 11 and is closed. FIG. 3 shows the state wherein the cartridge 1 is inserted in the optical disk recording/reproduction apparatus 11 and is open. FIGS. 4 and 5 show the arrangement of the cartridge 1 and the optical disks 2 and 3 according to the first embodiment of the present invention. FIG. 4 shows the state wherein the cartridge 1 is not inserted in the optical disk recording/reproduction apparatus 11 and is closed. FIG. 5 shows the state wherein the cartridge 1 is inserted in the optical disk recording/reproduction apparatus 11, and the upper optical disk 2 is unloaded. FIG. 6 shows the sectional arrangement of the cartridge 1 and the optical disks 2 and 3 according to the first embodiment of the present invention. FIG. 7 shows the state wherein the cartridge 1 is inserted in the optical disk recording/reproduction apparatus 11 in the first embodiment of the present invention. FIGS. 8A to 8H show the operation of recording/reproduction for the optical disks 2 and 3 in the first embodiment of the present invention.

Referring to FIG. 1, the optical disk recording/reproduction apparatus 11 of the present invention is constituted by the cartridge 1 for storing the two optical disks 2 and 3, a turntable 6 on which the optical disk 2 or 3 is mounted and rotated, a spindle motor 7 for rotating the turntable 6, an optical head 8 for recording/reproducing data by irradiating the optical disk 2 or 3 mounted on the turntable 6 with a light beam, an optical disk transfer unit 9 for transferring the optical disks 2 and 3 between the cartridge 1 and the turntable 6, a cartridge elevating unit 10 for positioning the cartridge 1 in the vertical direction, a base 12 (shown in FIGS. 8A to 8H) to which the spindle motor 7 and the optical head 8 are attached, a memory 13 capable of recording data for a time longer than the time required to exchange the optical disks 2 and 3 on the turntable 6, a loading mechanism (not shown) for loading and unloading the cartridge 1 in and from the optical disk recording/reproduction apparatus 11, and a positioner (not shown) for moving the optical head 8 attached to the base 12 in the radial direction.

As shown in FIGS. 2, 4, and 6, the two optical disks 2 and 3 are stored in the cartridge 1. The two optical disks 2 and 3 are respectively placed on rails 4 and 5 formed inside the cartridge 1. When the cartridge 1 is outside the optical disk recording/reproduction apparatus 11, an access window 14 of the cartridge 1 is closed to prevent dust and dirt from entering the cartridge 1.

As shown in FIG. 7, when the cartridge 1 is inserted in the optical disk recording/reproduction apparatus 11 to record/reproduce data, the cartridge 1 is loaded into the optical disk recording/reproduction apparatus 11. As shown in FIGS. 3 and 5, the access window 14 (not shown in FIGS. 3 and 5) of the cartridge 1 is opened to allow the optical disk transfer unit 9 to grip one of the two optical disks 2 and 3.

The operation of inserting the cartridge 1 in the optical disk recording/reproduction apparatus 11 and recording/reproducing data on/from the two optical disks 2 and 3 will be explained with reference to FIGS. 8A to 8H.

FIG. 8A shows the state wherein the cartridge 1 is inserted in the optical disk recording/reproduction apparatus 11.

As shown in FIG. 8B, the cartridge 1 is mounted on the cartridge elevating unit 10 by the loading mechanism (not shown). At this time, the loading mechanism opens the access window 14 of the cartridge 1. Then, the cartridge 1 is in a state wherein the two optical disks 2 and 3 can be inserted/extracted.

The cartridge elevating unit 10 moves up/down and positions the cartridge 1 so as to easily extract an optical disk subjected to recording/reproduction. More specifically, when data is recorded/reproduced on/from the upper optical disk 2, the cartridge elevating unit 10 positions the cartridge 1 at the first position. When data is recorded/reproduced on/from the lower optical disk 3, the cartridge elevating unit 10 positions the cartridge 1 at the second position higher than the first position. In FIG. 8B, the cartridge elevating unit 10 moves the cartridge 1 to the first position in order to record/reproduce data on/from the upper optical disk 2.

As shown in FIG. 8C, the optical disk transfer unit 9 moves parallel to the position where it can grip the optical disks 2 and 3 placed on the rails 4 and 5 inside the cartridge 1. The optical disk transfer unit 9 grips and holds an optical disk subjected to recording/reproduction from two sides. In this case, since the cartridge 1 is positioned at the first position, the optical disk transfer unit 9 holds the upper optical disk 2.

As shown in FIG. 8D, while holding the optical disk 2, the optical disk transfer unit 9 moves parallel to the position where the optical disk 2 can be mounted on the turntable 6. Note that the rails 4 and 5 supporting the optical disks 2 and 3 inside the cartridge 1 have widths enough to mount the outermost peripheral edges of the optical disks 2 and 3. The optical disk transfer unit 9 can grip the two sides of the optical disk 2 or 3. Therefore, in moving the optical disks 2 and 3, the recording/reproduction data surfaces of the optical disks 2 and 3 are not damaged.

As shown in FIG. 8E, the base 12 to which the optical head 8 and the spindle motor 7 are attached moves up. As the spindle motor 7 moves up, the turntable 6 attached to the spindle motor 7 also moves up, and the optical disk 2 is mounted on the turntable 6. The optical disk transfer unit 9 opens its arms to release the optical disk 2. The optical disk 2 rotates along with rotation of the spindle motor 7, the positioner (not shown) positions the optical head 8 at a desired position, and the optical head 8 irradiates the optical disk 2 with a laser beam. In this way, data can be recorded/reproduced on/from the optical disk 2.

The operation of exchanging the optical disk 2 with the optical disk 3 in order to record/reproduce data on/from the other optical disk 3 will be explained.

After the spindle motor 7 stops rotating, the optical disk transfer unit 9 grips and holds the optical disk 2 on the turntable 6 from the two sides. As shown in FIG. 8F, the base 12 to which the optical head 8 and the spindle motor 7 are attached moves down. As the spindle motor 7 moves down, the turntable 6 also moves down and apart from the optical disk 2. The optical disk transfer unit 9 moves parallel with holding the optical disk 2, and returns the optical disk 2 onto the rail 4 inside the cartridge 1. The optical disk transfer unit 9 opens its arms to release the optical disk 2.

The cartridge elevating unit 10 moves the cartridge 1 to the second position higher than the first position. The optical disk transfer unit 9 grips and holds the optical disk 3 newly subjected to recording/reproduction from the two sides.

As shown in FIG. 8G, while holding the optical disk 3, the optical disk transfer unit 9 moves parallel to the position where the optical disk 3 can be mounted on the turntable 6. The base 12 to which the optical head 8 and the spindle motor 7 are attached moves up. As the spindle motor 7 moves up, the turntable 6 also moves up, and the optical disk 3 is mounted on the turntable 6. The optical disk transfer unit 9 opens its arms to release the optical disk 3. The optical disk 3 rotates along with rotation of the spindle motor 7, the positioner (not shown) positions the optical head 8 at a desired position, and the optical head 8 irradiates the optical disk 3 with a laser beam. In this way, data can be recorded/reproduced on/from the optical disk 3.

The operation of unloading the cartridge 1 from the optical disk recording/reproduction apparatus 11 will be explained.

Upon completion of recording/reproduction of the optical disk 3, the optical disk transfer unit 9 grips and holds the optical disk 3 on the turntable 6 from the two sides after the spindle motor 7 stops rotating. As shown in FIG. 8H, the base 12 to which the optical head 8 and the spindle motor 7 are attached moves down. As the spindle motor 7 moves down, the turntable 6 also moves down and apart from the optical disk 3. The optical disk transfer unit 9 moves parallel with holding the optical disk 3, and returns the optical disk 3 onto the rail 5 inside the cartridge 1. The optical disk transfer unit 9 opens its arms to release the optical disk 3. The loading mechanism (not shown) unloads the cartridge 1 from the optical disk recording/reproduction apparatus 11. At this time, the loading mechanism closes the access window 14 of the cartridge 1.

According to the first embodiment, the optical disk transfer unit 9 inside the optical disk recording/reproduction apparatus 11 exchanges the optical disk between the cartridge 1 in which the two optical disks 2 and 3 are stored, and the turntable 6. The user need not exchange the optical disk and can record/reproduce data with a double capacity as if he/she handles a conventional cartridge.

In the first embodiment, the cartridge 1 for storing the two optical disks 2 and 3 is formed with the same thickness as that of the conventional cartridge for storing one optical disk. In the conventional cartridge, the optical disk rotates inside it. The conventional cartridge has a margin in the direction of thickness in order to avoid interference between the optical disk and the cartridge during rotation of the optical disk. To the contrary, in the first embodiment, since the optical disk recording/reproduction apparatus 11 unloads the optical disks 2 and 3 from the cartridge 1 and rotates them, no interference between the optical disks 2 and 3 and the cartridge 1 during rotation of the optical disks 2 and 3 need be considered. Therefore, the cartridge 1 can be formed with the same thickness as that of the conventional cartridge in consideration of even the margin for deflection of the optical disks 2 and 3.

For example, assuming that the conventional cartridge for the DVD-RAM or PD has a thickness of 8 mm, and the cartridge case has a wall thickness of 1 mm, the cartridge case has an internal height of 6 mm. When the two optical disks 2 and 3 are to be stored inside the cartridge case and have a thickness of 1.2 mm, a space of 1.2 mm can be ensured above, between, and below the two optical disks 2 and 3.

Since the cartridge 1 has the same thickness as that of the conventional cartridge, the optical disk recording/reproduction apparatus 11 of the first embodiment can easily attain the compatibility with the conventional cartridge. Since the cartridge 1 has the same size as that of the conventional cartridge, the user is free from any demerit caused by storing two optical disks and can handle the optical disk recording/reproduction apparatus as if he/she handles the conventional cartridge.

According to the first embodiment, the optical disk recording/reproduction apparatus can be kept small, unlike the disk changer optical disk recording/reproduction apparatus using a large cartridge, and does not require any complicated mechanism for realizing a double-sided access, unlike the optical disk recording/reproduction apparatus using a double-sided optical disk. As a result, the optical disk recording/reproduction apparatus 11 can be made compact and thin.

When data is to be recorded/reproduced on/from the two optical disks 2 and 3, the optical disks 2 and 3 subjected to recording/reproduction can be exchanged inside the optical disk recording/reproduction apparatus 11. The user can record/reproduce data on/from the two optical disks 2 and 3 without exchanging the optical disks 2 and 3 by himself/herself.

However, data cannot be recorded/reproduced while the optical disk on the turntable 6 is exchanged inside the optical disk recording/reproduction apparatus 11. Recording/reproduction of data is interrupted during exchange of the optical disks 2 and 3. Accordingly, the optical disk recording/reproduction apparatus 11 incorporates a memory 13 having a capacity enough to record data for a time longer than the time required to exchange the optical disk.

When the optical disks 2 and 3 must be exchanged during, e.g., recording, data to be recorded is stored in the memory 13. After the optical disk on the turntable 6 is exchanged, the data stored in the memory 13 is recorded on the optical disk. This allows continuous recording without any interruption even when the optical disks 2 and 3 must be exchanged.

When the optical disks 2 and 3 must be exchanged during reproduction, data to be reproduced is stored in the memory 13. While the optical disk on the turntable 6 is exchanged, the data stored in the memory 13 is externally output. This allows continuous reproduction without any interruption even when the optical disks 2 and 3 must be exchanged.

Using the memory 13 also allows continuous recording/reproduction when the servo for the optical disks 2 and 3 on the turntable 6 is disconnected due to shock or the like, and data cannot be recorded/reproduced until the servo recovers.

What is claimed is:

1. An optical disk recording/reproduction apparatus comprising:
a cartridge for storing two optical disks;
a turntable for mounting and rotating an optical disk;
an optical disk transfer unit for transferring the optical disk between said cartridge and said turntable; and
an optical head for irradiating the optical disk mounted on said turntable with a light beam to record/reproduce data.

2. An apparatus according to claim 1, wherein said cartridge has the same thickness as a thickness of a conventional cartridge for storing one optical disk.

3. An apparatus according to claim 1, wherein said cartridge comprises a closable access window for allowing said optical disk transfer unit to unload the optical disk.

4. An apparatus according to claim 1, wherein said cartridge comprises rails for holding the two optical disks at predetermined storage positions.

5. An apparatus according to claim 1, further comprising a cartridge elevating unit for positioning said cartridge in a vertical direction in order to selectively unload the optical disks from said cartridge by said optical disk transfer unit.

6. An apparatus according to claim 1, further comprising a memory capable of recording data for a time longer than a time required to exchange the optical disk on said turntable.
